(19) United States
(12) Patent Application Publication
(10) Pub. No.: US 2013/0094330 A1
(43) Pub. Date: Apr. 18, 2013

(54) METHODS AND APPARATUS FOR PASSIVE DETECTION OF OBJECTS IN SHALLOW WATERWAYS

(71) Applicants: Joel N. Holyoak, Lucas, TX (US); Theodore J. Wittliff, JR., Richardson, TX (US)

(72) Inventors: Joel N. Holyoak, Lucas, TX (US); Theodore J. Wittliff, JR., Richardson, TX (US)

(73) Assignee: RAYTHEON CORPORATION, Waltham, MA (US)

(21) Appl. No.: 13/272,799

(22) Filed: Oct. 13, 2011

(51) Int. Cl. H04B 13/02

(52) U.S. Cl. 367/131

(57) ABSTRACT

A method and system for detecting watercraft in shallow waterways. In one example, an underwater detection system includes an underwater power source, an acoustic sensor, a controller coupled to the power source and to the acoustic sensor and configured to detect a watercraft of interest based on acoustic signals generated by the watercraft of interest and received by the acoustic sensor, and a retractable communications system. The retractable communications system is configured to deploy a transmitter to the surface of the shallow water to report detection of a watercraft in the waterway and to retract the transmitter to a safe depth below the surface of the shallow waterway when not actively communicating.

### BACKGROUND

There is a need for monitoring and protection of maritime assets, such as oil platforms or harbors. Existing systems for monitoring waterways include surface search radar systems, high frequency surface wave radar systems, and aerostats (dirigibles with surface radar). A significant threat includes small, high-speed attack watercraft having low radar profiles; however, existing systems have limited ability to detect such watercraft. Land-stationed and platform-stationed surface search radar systems have limited range, generally between about 6 and 21 nautical miles depending on the height at which the radar can be deployed. With this limited range, these systems may not provide sufficient warning time for appropriate action to be taken. For example, high-speed attack boats can attain sufficient speeds such that intercept deployment can be problematic with the warning times presently provided by surface search radar systems. In addition, surface search radar systems generally suffer from high rates of false alarm. High frequency surface wave radar systems are limited to detection of large, slow-moving vessels and provide no capability to detect small watercraft over the horizon. Aerostats are in plain view, are subject to being withdrawn during poor weather conditions, and have associated recurring maintenance costs. In addition, radar-based detection systems require electronic counter-countermeasures (ECCM) to remain functional when under attack.

Fixed, underwater acoustic systems, such as a permanently-installed sea floor sonar network, provide additional mechanisms for threat detection in deep water environments, but are vulnerable to sabotage when the deployment waters are shallow. For example, these systems generally use sea floor cables to interconnect array elements and distribute power and communications, which can be easily destroyed or disabled in shallow waters. In addition, installation of such a system in a relatively small waterway can be observed, resulting in decreased usefulness since the opposition can be aware of the location of the monitoring sensors.

### SUMMARY OF INVENTION

There is a need for improved detection of high speed watercraft, such as attack boats or smuggling boats, particularly in shallow waterways around maritime assets or coastal access points. Accordingly, aspects and embodiments are directed to methods and apparatus for monitoring shallow waterways, detecting watercraft therein (including high speed watercraft), and communicating a warning or other information regarding detected watercraft to remote locations, such as a central control station or communications center associated with a protected asset or region. In one embodiment, the detection and/or communications may be accomplished using “stealth” systems, as discussed further below.

According to one embodiment, an underwater detection system comprises an underwater power source, an acoustic sensor configured detect underwater acoustic signals and to provide corresponding electrical signals, a controller coupled to the power source and to the acoustic sensor and configured to receive and process the electrical signals, to determine whether the acoustic signals were generated by a watercraft of interest, and to produce a warning signal responsive to determining that at least one acoustic signal was generated by the watercraft of interest, and a retractable communications system coupled to the controller and the power source and including a communications buoy configured to deploy to a water surface to transmit the warning signal and to be retracted below the water surface.

In one example of the underwater detection system the acoustic sensor includes a hydrophone. In another example, the retractable communications system includes a cable coupled to the communications buoy and a cable payout system coupled to the controller, and the controller is configured to control the cable payout system to deploy the communications buoy to the water surface and to retract the communications buoy below the water surface. In one example, the communications buoy includes a wireless transmitter configured to transmit the warning signal. The warning signal may include information identifying at least one of the watercraft of interest, the underwater detection system, and a geographical position of the underwater detection system. In another example, the communications buoy further includes a wireless receiver configured to receive control signals from a remote control station. The underwater power supply may include a fuel cell or battery, for example. The communications buoy may be further configured to transmit a low-battery status signal of the underwater power supply.

Another aspect is directed to a method of detecting watercraft in a shallow waterway using an underwater detection system. In one embodiment, the method comprises detecting underwater acoustic signals, processing the acoustic signals underwater to determine whether at least one of the acoustic signals was generated by a watercraft of interest, producing a warning signal responsive to determining that the at least one acoustic signal was generated by the watercraft of interest, deploying a communications buoy to a water surface of the shallow waterway, transmitting the warning signal from the communications buoy, and retracting the communications buoy to below the water surface after transmission of the warning signal is complete.

In one example of the method, deploying the communications buoy includes paying out a cable coupled to the communications buoy to deploy the communications buoy to the water surface. In another example, processing the acoustic signals includes analyzing a sound profile of the watercraft of interest. Producing the warning signal may include producing the warning signal including information identifying at least one of the watercraft of interest, the underwater detection system, and a geographical position of the underwater detection system. The method may further comprise transmitting from the communications buoy information identifying a power status of the underwater detection system. In one example, transmitting the warning signal includes transmitting the warning signal using a secure communications channel. The method may further comprise receiving a control signal for the underwater detection system. In one example, receiving the control signal includes receiving the control signal at the communications buoy while the communications buoy is at the water surface. In another example, receiving the control signal includes receiving a retrieval signal, and the method further comprises deploying the communications buoy to the water surface responsive to receiving the retrieval signal. In another example, retracting the communications buoy includes retracting the communications buoy to a predetermined depth below the water surface, the predetermined depth being below a maximum draft depth of watercraft expected in the shallow waterway.

According to another embodiment, an underwater watercraft detection system is configured to be deployed in a shallow waterway and comprises an underwater power source, an acoustic sensor, a controller coupled to the power source and to the acoustic sensor and configured to detect a watercraft of interest based on acoustic signals generated by the watercraft of interest and received by the acoustic sensor, a retractable communications buoy coupled to the controller, and a cable system including a cable coupled to the communications buoy and a cable payout system coupled to the power source and the controller. The controller is configured to control the cable payout system to deploy the communications buoy to a surface of the shallow waterway, to control the communications buoy to transmit a warning signal responsive to detection of the watercraft of interest, and to control the cable payout system to retract the communications buoy to a predetermined depth below the surface of the shallow waterway subsequent to completion of transmission of the warning signal.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a functional block diagram of one example of a stealth underwater detection system according to aspects of the invention;

FIG. 2 is a functional block diagram of one example of the system of FIG. 1 deployed in a shallow waterway according to aspects of the invention;

FIG. 3 is a functional block diagram of another example of the system of FIG. 1 deployed in a shallow waterway where the communications buoy is retracted according to aspects of the invention;

FIG. 4 is a flow diagram illustrating one example of a process of detecting high speed watercraft in a shallow waterway according to aspects of the invention; and

FIG. 5 is a functional block diagram of another example of the system of FIG. 1 deployed in a shallow waterway where the communications buoy is deployed according to aspects of the invention.

### DETAILED DESCRIPTION

Aspects and embodiments are directed to a system and method for detecting watercraft, including high speed watercraft, in shallow waterways, such as littoral waters for example. According to one embodiment, detection of the watercraft, and optionally communication of the detection, is done by stealth mechanisms. For example, as discussed further below, in one embodiment an underwater detection system includes a passive acoustic sensor, such as a sonar sensor, along with processing electronics and a long-term underwater power supply that are deployed underwater. The system may further include a stealth, low-probability of detection communications system. In one example, as discussed further below, the system includes a retractable communications buoy that can be deployed to the water surface for communications, and retracted to a “hiding” depth underwater when not actively communicating. Embodiments of the system leverage the recognition that an acoustic sensor, such as a sonar sensor for example, has long range in shallow waters, and therefore can provide coverage of waterways with sufficient time for countermeasures to be taken responsive to detection of a hostile watercraft incursion. In addition, use of a passive acoustic sensor for the detection and a stealth communications system, such as the Iridium™ satellite-based communications system, for example, reduces the need for electronic counter-countermeasures (ECCM). The detection system may be clandestinely deployed at random locations in the shallow waterways, and may be easily retrieved and redeployed in another location, as discussed below.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

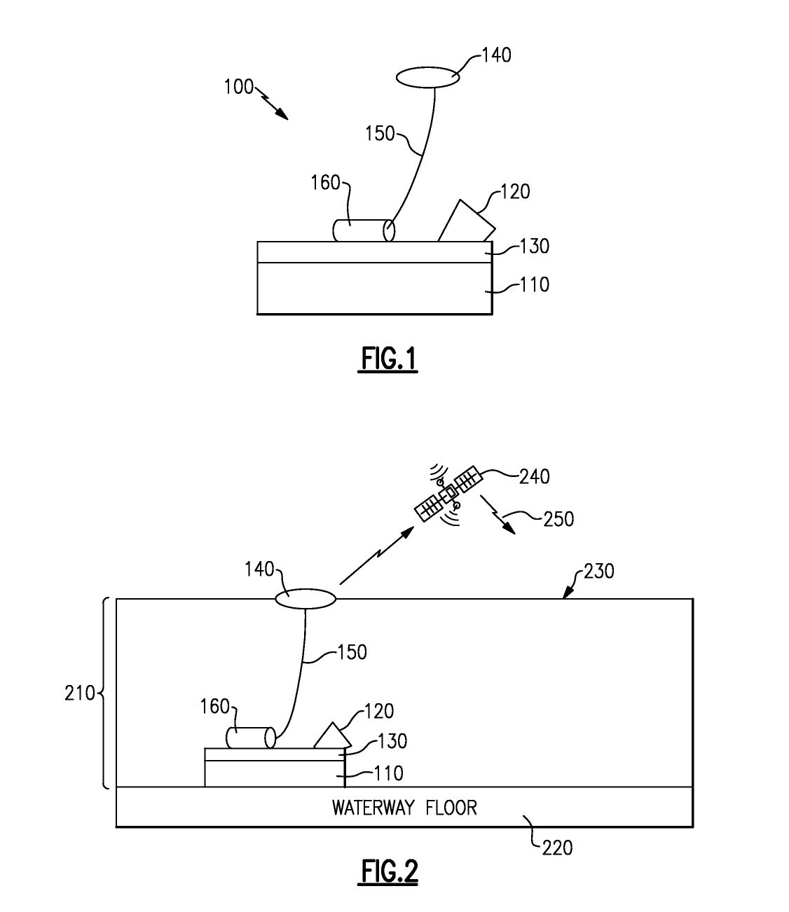

Referring to FIG. 1, there is illustrated a functional block diagram of one example of an underwater threat detection system according to one embodiment. The system 100 includes an underwater power source 110, an acoustic sensor 120, processing electronics 130 (also referred to herein as controller 130), and a communications buoy 140 including a wireless transmitter (not shown). In one example, the communications buoy 140 is a stealth, low-probability of detection system, as discussed in more detail below. The communications buoy 140 is coupled to a deployment cable system, including a buoy cable 150 and cable payout system 160 that allow the communications buoy to be raised and lowered, as necessary. The underwater power source 110 is configured to provide power to the system components, including, for example, the communications buoy 140, cable payout system 160, acoustic sensor 120 and controller 130. The underwater power source 110 may include, for example, a battery or fuel cell that is disposed in a waterproof housing such that it can operate underwater.

According to one embodiment, the system 100 is deployed on the floor 220 of a shallow waterway 210, as illustrated in FIG. 2. As discussed above, the waterway 210 may include littoral waters, a shallow gulf region, shallow lakes or other inland bodies of water, or coastal access points (e.g., harbors or deltas), etc. In one example, the waterway 210 may have an average depth in a range of approximately 150 meters (˜500 feet) and/or a maximum depth of approximately 250 to 300 meters (˜800 to 1000 feet). According to various aspects, the system 100 is particularly applicable to shallow waterways since the coverage provided the acoustic sensor is limited by the distance between the sensor (on the floor 220 of the waterway) and the watercraft on the surface. Thus, if the waterway 210 is deep, the sensor 120 may provide a smaller range of coverage due to the distance that the acoustic signals from the watercraft travel through the water to reach the sensor; whereas the system may have a greater range of coverage in shallow waters. The cable 150 and cable payout system 160 may be used to raise the communications buoy 140 to the surface 230 of the waterway 210, where it may communicate with a satellite 240, for example, and then retract the communications buoy below the water surface.

Referring to FIG. 3, in one embodiment, in the retracted position, the communications buoy 140 may be held at a depth that is below the screw depth 310 of deep-draft vessels 320, such as tankers, cargo ships or cruise ships. For example, large supertankers may have a draft of up to about 25 meters (82 feet), and very large crude carriers (VLCCs) have drafts that average about 21.2 meters (69.5 feet). Thus, in the retracted position the communications buoy 140 may be maintained at a depth sufficient to avoid damage by deep-draft vessels, namely between the waterway floor 220 and depth 310. The communications buoy may remain below depth 310 while the system 100 is in a monitoring mode, listening for sounds from watercraft of interest, and may be deployed to the surface 230 when communication with the satellite 240 is desired. Thus, the communications system buoy 140 may remain hidden from view below the water surface 230 when it is not actively communicating thereby greatly reducing the probability that it would be detected by a hostile party. In addition, the buoy may be made relatively small and constructed such that it is not easily visible when on the surface 230.

According to one embodiment, the acoustic sensor 120 is configured to receive acoustic signals, such as the sound waves that are generated by cavitations and/or screw(s) or propeller(s) of watercraft and other detectible phenomena of these vessels, and provide corresponding electrical signals to the controller 130. The acoustic sensor 120 may be a sonar sensor. In one embodiment, the acoustic sensor 120 includes one or more hydrophones. A hydrophone is a microphone designed with a good acoustic impedance match to water such that it can be used underwater for recording or listening to underwater sound. The hydrophone may include a piezoelectric transducer that converts the received acoustic signals (pressure waves) into the electrical signals to be provided to the controller 130. The controller 130 may be configured to analyze the signals from the acoustic sensor and determine whether the sound is produced by an object of interest. In particular, the controller 130 may be programmed to recognize specific characteristics of the acoustic signals associated with watercraft of interest and thus detect these watercraft. For example, high speed attack boats and other high speed watercraft generate high frequency screw sounds and cavitations that are recognizable, and therefore sound profiles associated with such watercraft can be characterized. In addition to being high-speed, these watercraft are generally small and/or have low radar profiles, making them difficult to detect with surface radar systems. However, since the sound profiles they generate have recognizable characteristics, the controller 130 may be programmed to detect the specific sound profiles associated with such watercraft.

In shallow waterways, acoustic signals may travel large distances, and therefore the range of the acoustic sensor 120 may be several nautical miles. In addition, since the system 100 may be deployed anywhere within the shallow waterway, one or more systems may be strategically deployed some distance from an asset or region to be protected. Therefore, the detection system 100 may be able to detect high speed watercraft at sufficient distances away that a warning can be communicated to the remote control station with sufficient time for countermeasures, such as deployment of intercept vehicles, to be taken. The system 100 may be used to supplement and effectively extend the range of a land-stationed or platform-stationed radar system. Multiple systems 100 may also be deployed at varying distances from an asset or region to be protected, for example, in concentric arrangements about an asset, to provide several warnings and/or positional information about the high speed watercraft over time. In one example, multiple systems 100 may be deployed as a screen at some radius from the potential attack point, for example, at 35 to 40 nautical miles from the potential attack point. As this circumference is quite large, in one example, the systems 100 may be strategically deployed at areas where the angle of attack is most probable.

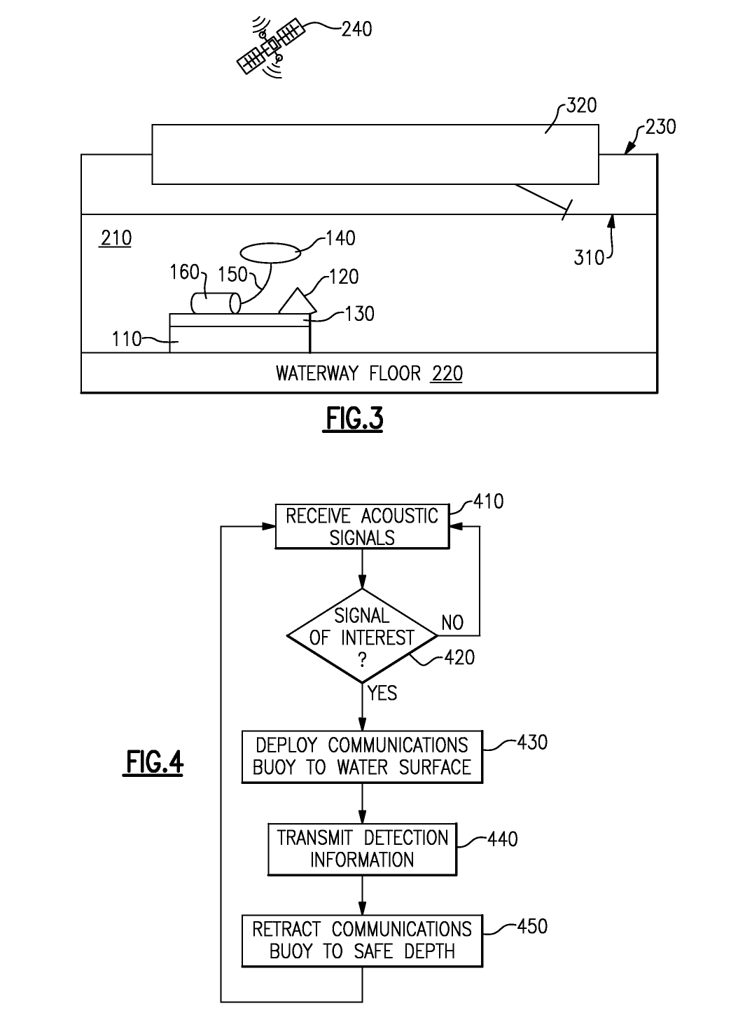

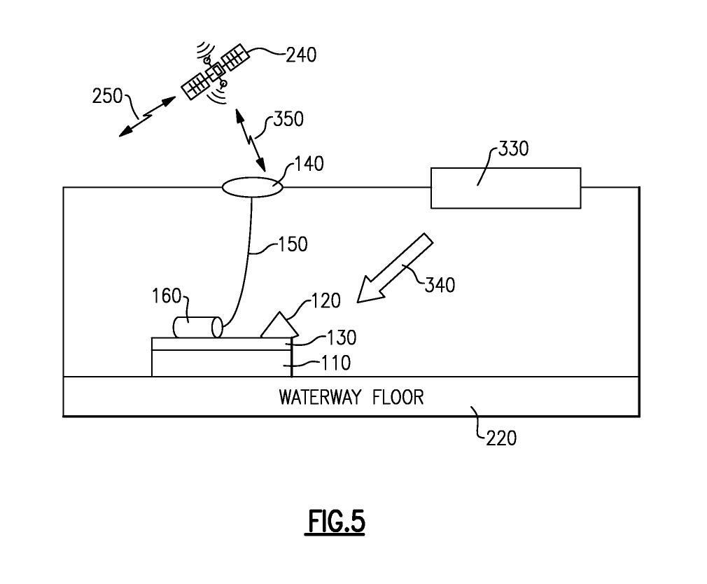

Referring to FIG. 4 there is illustrated a flow diagram of one example of operation of the underwater detection system 100. As discussed above, once deployed, the system 100 may rest on the floor 220 of a shallow waterway 210 and may monitor the waterway 210 for acoustic signals associated with watercraft of interest. Thus, step 410 includes receiving acoustic signals with the acoustic sensor 120. The controller 130 may process the received acoustic signals to determine whether or not the signals are likely generated by a watercraft of interest (step 420). In one embodiment, the controller 130 may be programmed to recognize sound profiles associated with certain types of high speed watercraft, such as attack boats, as discussed above. In the monitoring mode of the system 100, the communications buoy 140 may be in a retracted position below the surface 230 of the waterway 210, and optionally below an expected maximum screw or draft depth of deep-draft vessels that may traverse the waterway. Accordingly, if the controller 130 determines, based on its processing of the received acoustic signals, that a watercraft of interest has been detected, the controller may control the cable payout system 160 to deploy the communications buoy to the surface 230 (step 430) where it may transmit a signal indicating detection of the watercraft of interest (step 440).

For example, referring to FIG. 5, in one example, a high speed attack boat 330 generates an acoustic signal 340 which is detected by the acoustic sensor 120. The controller 130 recognizes the acoustic signal, and causes the communications buoy to be deployed to the surface 230. The communications buoy transmits a signal 350 to the satellite 240 which is a low probability intercept (LPI) communications device, thereby providing a “stealth” aspect to the communications system, as discussed above. The satellite 240 relays the signal to a remote control station, represented by link 250. In one embodiment, the signal 350 includes a warning or other information indicating that the attack boat 330 has been detected. As discussed above, numerous systems 100 may be deployed around a particular asset or region (e.g., a harbor or coastline) being protected. Accordingly, in one example, the information in signal 250 includes a unique identifier associated with the system 100 such that the remote control station may identify which system 100 has detected the attack boat 330. The information in signal 250 may include parameters or identification information identifying the type of watercraft detected, and/or positional information indicating the location of the system 100.

According to one embodiment, the communications buoy 140 may include a position sensor, such as a GPS (global positioning system) unit, such that the location of the communications buoy may be accurately determined. From the location of the communications buoy 140, the location of the underwater system 100 may be inferred or determined. There may be some offset between the location of the communications buoy 140 and the location of the underwater system 100; however, that offset will be small since the depth of the waterway 210 is shallow. By including a position sensor in the system 100, the ship or other vehicle that deploys the system(s) in the waterway 210 need not keep a record of the deployment location(s), since the system may self-determine its location. In another example, the controller 130 may be pre-programmed with position information based on a known, predetermined deployment location. According to another example, where multiple systems 100 are deployed in a given waterway 210, if two or more of the systems 100 detect a watercraft, and each provides the signal 250 including the detection information and the system's position information, the remote control station may determine additional position/movement information about the detected watercraft based on the locations of and detection information provided by each system 100.

In one embodiment, the communications buoy 140 is configured to communicate using a secure communications network, such as the Iridium™ satellite communications system, for example. Using the Iridium™ system may provide benefits and increase the stealth aspects of the system 100. In particular, the Iridium™ satellite constellation includes low-earth orbit satellites which, even with a low-earth orbit, provide a communication transmit angle that is almost vertical, meaning that the transmission may not be detected unless the interceptor is very close to or directly above the communications buoy 140. However, the communications buoy 140 may be configured to use any of numerous communication systems, networks or protocols for linking to the remote control station, not limited to the Iridium™ system or satellite-based systems.

According to one embodiment, in addition to transmitting the warning signal, the communications buoy may also receive signals from the remote control station, optionally via satellite 240, while at the water surface 230. Accordingly, the communications buoy may include a wireless receive in addition to the wireless transmitter. This may allow additional programming, parameter data (e.g., updated information regarding watercraft of interest), and control signals to be provided to the system 100 after its deployment in the shallow waterway 210. The communications buoy may also transmit information to the remote control station in addition to the warning signal. For example, if the underwater power supply is reaching the end of its life (e.g., the battery is low), the communications buoy may transmit this information to the remote control station. A decision can then be made to retrieve the system 100, to refurbish it (e.g., replace or recharge the battery), and redeploy it in the same or a different location.

Referring again to FIG. 4, after the communications buoy has transmitted the signal 350, the communications buoy may be retracted to the monitoring depth (step 450). Thus, the system 100 may provide a stealth detection system in which the communications buoy is predominantly hidden in the retracted position, and deploys briefly to the surface 230 to communicate over an optionally secure communications channel, before again being retracted to the monitoring depth. In one embodiment, as part of step 420, the controller 130 may also be programmed to detect sound profiles associated with deep-draft vessels so that the communications buoy 140 may be retracted to a deeper position if necessary. In another embodiment, the acoustic sensor 120 and controller 130 are further configured to detect and process acoustic communications/control signals that may be sent to the system 100 from a surface ship or submarine. This may provide an alternate method of communicating additional programming, parameter data, and control signals to the system 100 after its deployment in the shallow waterway 210.

In another example, a surface ship may transmit an acoustic signal to the system 100 to cause the communications buoy to be deployed to the surface so that the system 100 can be retrieved by the surface ship. For example, as discussed above, the system 100 may signal the remote control station when the underwater power supply is running low. Accordingly, a surface ship may be sent to retrieve the system 100, and may signal the system 100 to deploy the communications buoy when the ship is in position to retrieve the system. In one example, retrieval may be accomplished using the cable 150 and cable payout system 160. For example, the cable 150 may include a relatively light-weight section (used to deploy and retract the communications buoy) that can be retrieved by the surface ship, and which is connected to a heavier cable section that can be used to lift the system 100 from the waterway floor 220 and retrieve it to the ship.

Thus, aspects and embodiments provide a stealth, easily redeployable, acoustic detection system, optionally configured with secure, low-probability of detection communications, to detect and report incursions of high-speed watercraft in shallow waterways. Embodiments of the detection system may be used in numerous applications including, for example, protection of maritime assets, such as oil platforms, and monitoring or protection of outlets of inland waterways, littoral waters, or coastlines (e.g., for drug interdiction).

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. An underwater detection system comprising:
an underwater power source;
an acoustic sensor configured detect underwater acoustic signals and to provide corresponding electrical signals;
a controller coupled to the power source and to the acoustic sensor and configured to receive and process the electrical signals, to determine whether the acoustic signals were generated by a watercraft of interest, and to produce a warning signal responsive to determining that at least one acoustic signal was generated by the watercraft of interest; and
a retractable communications system coupled to the controller and the power source and including a communications buoy configured to deploy to a water surface to transmit the warning signal and to be retracted below the water surface.

2. The underwater detection system of claim 1, wherein the acoustic sensor includes a hydrophone.

3. The underwater detection system of claim 1, wherein the retractable communications system includes a cable coupled to the communications buoy and a cable payout system coupled to the controller, the controller being configured to control the cable payout system to deploy the communications buoy to the water surface and to retract the communications buoy below the water surface.

4. The underwater detection system of claim 3, wherein the communications buoy includes a wireless transmitter configured to transmit the warning signal.

5. The underwater detection system of claim 4, wherein the warning signal includes information identifying at least one of the watercraft of interest, the underwater detection system, and a geographical position of the underwater detection system.

6. The underwater detection system of claim 4, wherein the communications buoy further includes a wireless receiver configured to receive control signals from a remote control station.

7. The underwater detection system of claim 1, wherein the underwater power supply includes a fuel cell.

8. The underwater detection system of claim 1, wherein the underwater power supply includes a battery.

9. The underwater detection system of claim 8, wherein the communications buoy is further configured to transmit a low-battery status signal.

10. A method of detecting watercraft in a shallow waterway using an underwater detection system, the method comprising:
detecting underwater acoustic signals;
processing the acoustic signals underwater to determine whether at least one of the acoustic signals was generated by a watercraft of interest;
producing a warning signal responsive to determining that the at least one acoustic signal was generated by the watercraft of interest;
deploying a communications buoy to a water surface of the shallow waterway;
transmitting the warning signal from the communications buoy; and
retracting the communications buoy to below the water surface after transmission of the warning signal is complete.

11. The method of claim 10, wherein deploying the communications buoy includes paying out a cable coupled to the communications buoy to deploy the communications buoy to the water surface.

12. The method of claim 10, wherein processing the acoustic signals includes analyzing a sound profile of the watercraft of interest.

13. The method of claim 10, wherein producing the warning signal includes producing the warning signal including information identifying at least one of the watercraft of interest, the underwater detection system, and a geographical position of the underwater detection system.

14. The method of claim 10, further comprising transmitting from the communications buoy information identifying a power status of the underwater detection system.

15. The method of claim 10, wherein transmitting the warning signal includes transmitting the warning signal using a secure communications channel.

16. The method of claim 10, further comprising receiving a control signal for the underwater detection system.

17. The method of claim 16, wherein receiving the control signal includes receiving the control signal at the communications buoy while the communications buoy is at the water surface.

18. The method of claim 16, wherein receiving the control signal includes receiving a retrieval signal, and further comprising:
deploying the communications buoy to the water surface responsive to receiving the retrieval signal.

19. The method of claim 10, wherein retracting the communications buoy includes retracting the communications buoy to a predetermined depth below the water surface, the predetermined depth being below a maximum draft depth of watercraft expected in the shallow waterway.

20. An underwater watercraft detection system configured to be deployed in a shallow waterway and comprising:
an underwater power source;
an acoustic sensor;
a controller coupled to the power source and to the acoustic sensor and configured to detect a watercraft of interest based on acoustic signals generated by the watercraft of interest and received by the acoustic sensor;
a retractable communications buoy coupled to the controller; and
a cable system including a cable coupled to the communications buoy and a cable payout system coupled to the power source and the controller;
wherein the controller is configured to control the cable payout system to deploy the communications buoy to a surface of the shallow waterway, to control the communications buoy to transmit a warning signal responsive to detection of the watercraft of interest, and to control the cable payout system to retract the communications buoy to a predetermined depth below the surface of the shallow waterway subsequent to completion of transmission of the warning signal.
